(19) United States
(12) Patent Application Publication
(10) Pub. No.: US 2007/0061826 A1
(43) Pub. Date: Mar. 15, 2007

(54) Micro-optical pickup head

(75) Inventors: Ming-Ching Wu, Taipei (TW); Wei-Leun Fang, Taipei (TW); Sheng-Fa Hou, Taipei (TW); Pei-Ching Kuo, Taipei (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/449,750

(22) Filed: Jun. 9, 2006

(30) Foreign Application Priority Data
Sep. 14, 2005 (TW) 94131704

(51) Int. Cl. G11B 7/00

(52) U.S. Cl. 720/672

(57) ABSTRACT

A micro-optical pickup head comprising a frame, a lens, a carrier, a lever and a focusing actuator is provided. The carrier is disposed in the frame for carrying the lens. The lever has an effort arm, a load arm and a supporting portion disposed between the effort arm and the load arm. The length of the load arm is larger than the length of the effort arm. The load arm is connected to the carrier. The supporting portion is fixed on the frame and used as a fulcrum of the lever. Besides, the focusing actuator is used for applying a force on the effort arm for enabling the carrier to move along a focusing direction.

This application claims the benefit of Taiwan application Serial No. 94131704, filed Sep. 14, 2005, the subject matter of which is incorporated herein by reference.

### BACKGROUND OF THE INVENTION

1. Field of the Invention

The invention relates in general to an optical pickup head, and more particularly to an optical pickup head manufactured according to a semiconductor manufacturing process.

2. Description of the Related Art

Optical pickup head is a critical part in the hardware structure of an optical disc driver. The performance of the optical pickup head has much to do with the speed and density in accessing data. In response to the future demand in high-density data storage, the track pitch of the disc has become as narrow as only few nano meters. According to the quality and structural design of current optical pickup heads, the accuracy of positioning and the system accessing speed can hardly be improved. Therefore, it is necessary to develop a micro-optical pickup head possessing the features of high positioning precision and fast accessing speed in response to the future demand in optical storage. In United State Patent No. US 2004/0202101 A1, Kim et al. disclosed a method of using micro-electromechanical (MEMS) technology to form a lubricant coating on an optical pickup head to reduce the size and the manufacturing cost of the optical pickup head. Jong et al. disclosed a micro-optical pickup head module configured according to a micro electromechanical technology in the 12th IEEE International Conference on Solid State Sensors, Actuators, and Microsystems. It can be seen from the above disclosures that the micro electromechanical technology is the mainstream trend in regards to the future development of the optical pickup head.

Micro electromechanical optical pickup head can adopt a comb actuator for tracking and focusing. Referring to FIGS. 1A˜1B, movements of conventional comb actuator are illustrated. As shown in FIG. 1A, the comb actuator 10, comprises a comb portion 12 and a comb portion 14. The comb portion 14 is fixed on a still surface via an elastomer 16. When a positive voltage and a negative voltage are respectively applied to the comb portion 12 and the comb portion 14, an attraction is generated between the two comb portions to pull the comb portion 14 torward the comb portion 12. When the bias voltages removed, the force of the elastomer 16 enables the comb portion 14 to return to the original position. However, when the movement of the comb portion 14 is too large, the force of the elastomer 16 may lose its balance and cause the comb portion 14 to tilt and become electrically conducted with the comb portion 12. Consequently, the comb actuator 10 may be burnt down as shown in FIG. 1B. Therefore, the operating range of the conventional comb actuator can not be too large. As a result, when the conventional comb actuator is applied in the tracking and focusing of an optical pickup head, the movement of the conventional comb actuator is restricted.

### SUMMARY OF THE INVENTION

It is therefore an object of the invention to provide an optical pickup head comprising a frame, a lens, a carrier, a lever, and a focusing actuator. The carrier is disposed in the frame for carrying the lens. The lever has an effort arm, a load arm, and a supporting portion disposed between the effort arm and the load arm. The length of the load arm is larger than the length of the effort arm. The load arm is connected to the carrier. The supporting portion is fixed on the frame and used as a fulcrum of the lever. Besides, the focusing actuator is used for applying a force on the effort arm for enabling the carrier to move along a focusing direction.

In an embodiment, the optical pickup head further comprises a tracking actuator disposed on the frame for controlling the frame to move along a tracking direction. The tracking actuator can be a comb tracking actuator having a pair of comb electrodes. The optical pickup head further comprises a flexible linking element and a flexible supporting element. The flexible linking element is used for linking the carrier and the load arm for enabling the load arm to drive the carrier to move along focusing direction. The flexible supporting element is used for fixing the supporting portion on the frame for enabling the lever to rotate with respect to the frame.

In an embodiment, the carrier, the lever, and the focusing actuator are manufactured according to a semiconductor manufacturing process. The material of the focusing actuator includes monocrystalline silicon. The optical pickup head further comprises a protection cover having an accommodation space for accommodating the lens. The material of the protection cover includes a glass substrate or a quartz substrate. The protection cover comprises a top cover and a bottom cover respectively having a recess to form the accommodation space. The top cover further can have a photo-diffracting element disposed thereon.

The invention achieves the above-identified object by providing a focusing method of an optical pickup head. Firstly, a carrier disposed in a frame for carrying a lens is provided. And a focusing device comprising a lever and a focusing actuator is provided. The lever has an effort arm, a load arm, and a supporting portion disposed between the effort arm and the load arm. The length of the load arm is larger than the length of the effort arm. The focusing actuator is used for applying a force on an effort end of the effort arm. The carrier is connected to a load end of the load arm. The supporting portion is fixed on the frame and used as a fulcrum of the lever. Next, the focusing actuator applies a force on the effort arm to generate a first shift at the effort end. Finally, a second shift larger than the first shift is generated at the carrying end according to the lever principle and the first shift for enabling the load arm to drive the carrier to move along a focusing direction.

In an embodiment, the focusing actuator is a comb focusing actuator and has a pair of comb electrodes. The present method further comprises applying a voltage on the comb focusing actuator for enabling the comb electrodes to have opposite polarities, so that an attraction is generated between the two comb electrodes.

The invention further achieves the above-identified object by providing a focusing device. The focusing device is disposed on a frame of an optical pickup head for driving a carrier to move along a focusing direction. The focusing device comprises a lever and a focusing actuator. The lever has an effort arm, a load arm, and a supporting portion disposed between the effort arm and the load arm. The carrier is connected to the load arm. The supporting portion is fixed on the frame and used as a fulcrum of the lever. Besides, the focusing actuator is used for applying a force on the effort arm. The length of the load arm is larger than the length of the effort arm.

In an embodiment, the focusing device is manufactured according to a semiconductor manufacturing process and comprises a flexible linking element and a flexible supporting element. The flexible linking element is used for linking the load arm and the carrier. The flexible supporting element is used for fixing the supporting portion on the frame.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIGS. 1A˜1B (PriorArt) illustrate the movement of conventional comb actuator;

FIG. 2 illustrates an optical pickup head of the optical disc driver according to a preferred embodiment of the invention;

FIG. 3 illustrates an enlarged diagram of a downward focusing device of FIG. 2;

FIG. 4 illustrates an enlarged diagram of an upward focusing device of FIG. 2;

FIG. 5 illustrates the optical pickup head and its protection cover according to a preferred embodiment of the invention;

FIG. 6A illustrates the upward focusing device before the lever action according to a preferred embodiment of the invention; and

FIG. 6B illustrates the upward focusing device after the lever action according to a preferred embodiment of the invention.

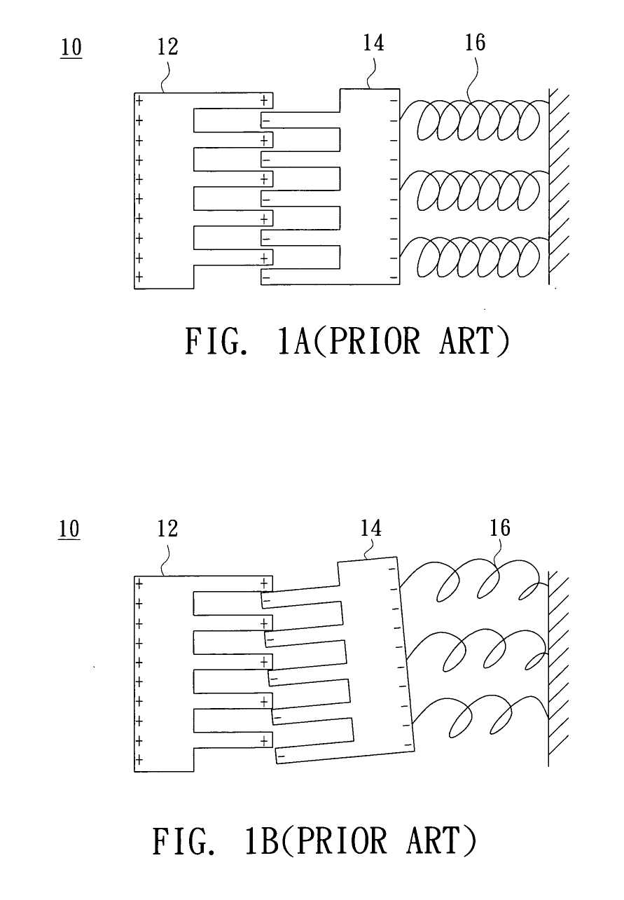

### DETAILED DESCRIPTION OF THE INVENTION

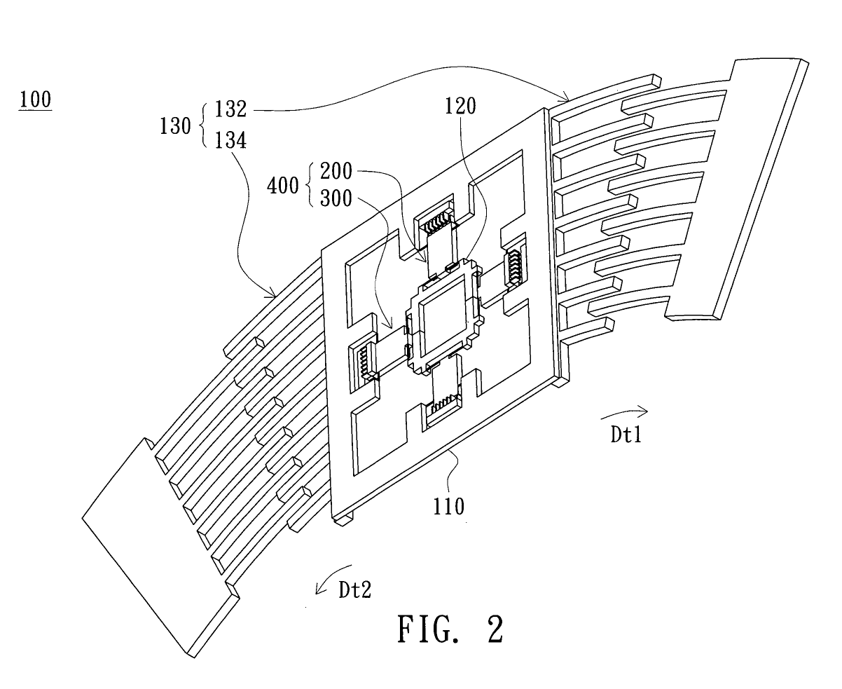

FIG. 2 illustrates an optical pickup head of the optical disc driver according to a preferred embodiment of the invention. The optical pickup head 100 comprises a frame 110, a carrier 120, a tracking device 130 and a focusing device 400. The carrier 120 is disposed in the frame and has an elastomer for retaining and fixing a lens (not illustrated in the drawing).

The tracking device 130 is used for controlling the frame 110 to move along a tracking direction. The tracking device 130 comprises a first comb tracking actuator 132 and a second comb tracking actuator 134 respectively disposed on two opposite sides of the frame 110. Each of the first comb tracking actuator 132 and the second comb tracking actuator 134 includes a pair of comb portions. One comb portion is disposed on the frame 110, while the other comb portion is disposed on a sled or a cantilever (not illustrated in the drawing) carrying the optical pickup head 100. Take the first comb tracking actuator 132 for example. By applying a voltage to make the two comb portions have opposite polarities, the first comb tracking actuator 132 can drive the carrier 120 to move towards a first tracking direction Dt1. Similarly, the second comb tracking actuator 134 can drive the carrier 120 to move towards a second tracking direction Dt2. Besides, the comb portion can be designed to be in an arc shape so that the operating range in tracking direction is increased.

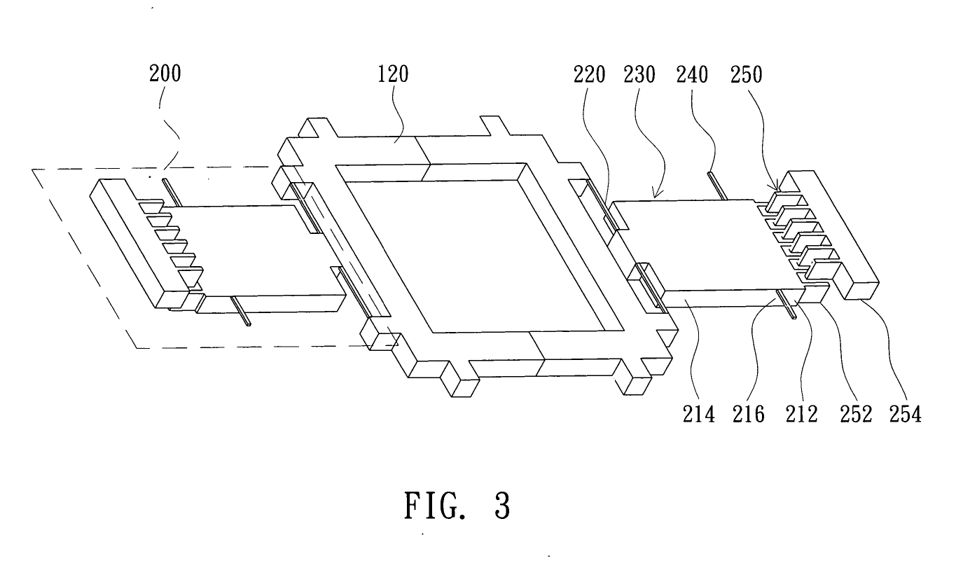

The focusing device 400 of the present embodiment of the invention is capable of controlling the carrier 120 to move towards a first focusing direction or a second focusing direction. The focusing device 400 can further have a pair of downward focusing devices 200 and a pair of upward focusing devices 300 used for controlling the upward focusing and the downward focusing, respectively. Referring to FIG. 3, an enlarged diagram of a downward focusing device of FIG. 2 is shown. The downward focusing device 200 comprises a lever 230, a comb focusing actuator 250, a flexible linking element such as a flexible linking shaft 220 formed by a thin film shaft, and a flexible supporting element such as a flexible supporting shaft 240 formed by a thin film shaft. The lever 230 can be divided into three portions, namely, an effort arm 212, a load arm 214, and a supporting portion 216 disposed between the effort arm 212 and the load arm 214. The supporting portion 216 is disposed closer to the effort end, so that the length of the load arm 214 is larger than the length of the effort arm 212.

The lever 230 is connected with the carrier 120 by using the flexible linking shaft 220 connecting to the load arm 214, and disposes the supporting portion on the frame 110 by using the flexible supporting shaft 240. The comb focusing actuator 250 comprises a pair of comb portions 252 and 254, respectively disposed on the effort arm 212 of the lever 230 and the frame 110 of FIG. 2. The comb portion 252 is disposed at a position lower than the comb portion 254. When a voltage is applied on the comb focusing actuator 250, the comb portions 252 and 254 have opposite polarities so that an attraction is generated between the two comb portions. Since the comb portion 254 is disposed on the frame 110 of FIG. 2, the comb portion 252 is driven upward and brings the effort arm 212 to generate an upward shift. Since the lever 230 is fixed on the frame 110 of FIG. 2 by using the flexible supporting shaft 240, the lever 230 is rotated with respect to the frame 110 of FIG. 2 and brings the load arm 214 to generate a downward shift. The load arm 214 is connected to the carrier 120 via a flexible linking shaft 220, so that the load arm 214 is rotated with respect to the carrier 120 and brings the carrier 120 to move downward.

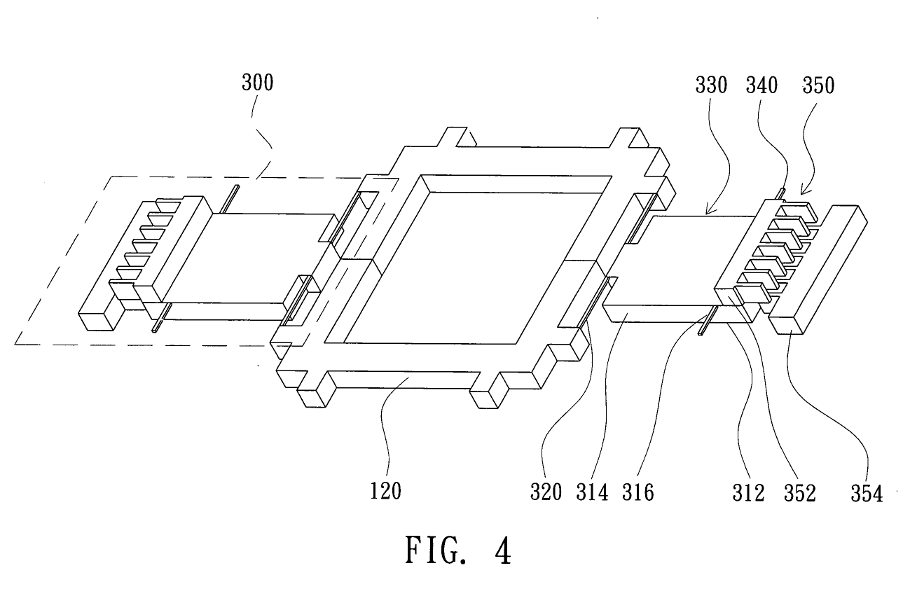

Referring to FIG. 4, an enlarged diagram of an upward focusing device of FIG. 2 is shown. The upward focusing device 300 differs with the downward focusing device 200 in the way of disposing the comb focusing actuator 350. The comb focusing actuator 350 comprises two comb portions 352 and 354, respectively disposed on the effort arm 312 of the lever 330 and the frame 110 of FIG. 2. The comb portion 352 is disposed at a position higher than the comb portion 354. When a voltage is applied on the comb focusing actuator 350, the comb portions 352 and 354 have opposite polarities so that an attraction is generated between the two comb portions. Since the comb portion 354 is disposed on the frame 110 of FIG. 2, the comb portion 352 is driven downward and brings the forcing arm 312 to generate a downward shift. Since the lever 330 is fixed on the frame 110 of FIG. 2 via a flexible supporting shaft 340, the lever 330 is rotated with respect to the frame 110 of FIG. 2 for enabling the effort arm 312 to generate a downward shift. The load arm 314 is also connected to the carrier 120 via a flexible linking shaft 320, so that the load arm 314 is rotated with respect to the carrier 120 and drives the carrier 120 to move upwardly. Thus, the lens (not illustrated in the drawing) disposed on the carrier 120 can perform the focusing operation by controlling the carrier 120 to move upward or downward to via the downward focusing device 200 and the upward focusing device 300.

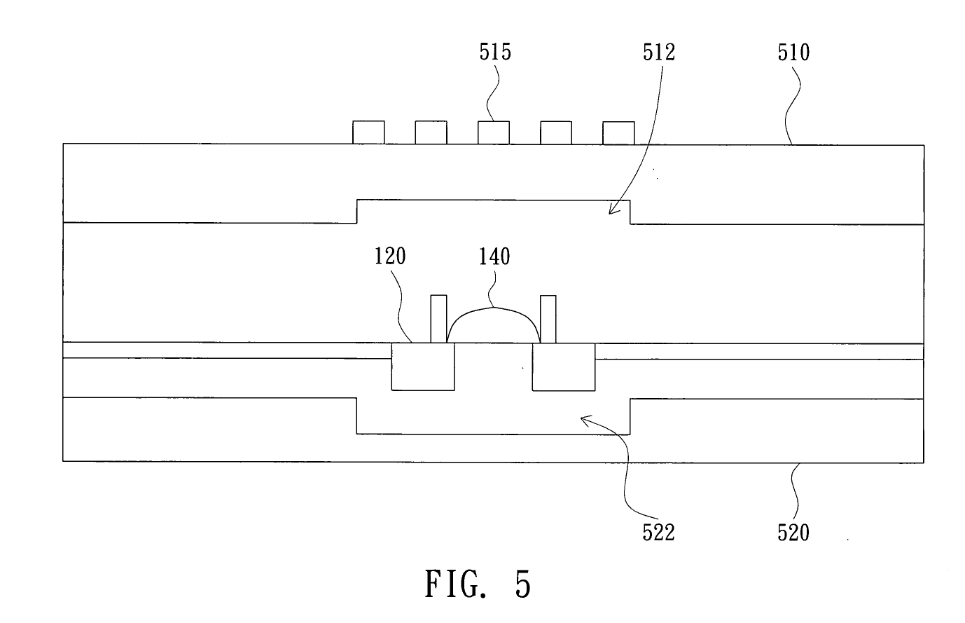

Referring to FIG. 5, the optical pickup head and its protection cover according to a preferred embodiment of the invention is shown. The lens 140 is carried by the carrier 120 and is disposed inside the accommodation space formed by the recess 512 of the top cover 510 and the recess 522 of the bottom cover 520. The material of the top cover and the bottom cover includes transparent materials such as a glass substrate or a quartz substrate, so that the light source can pass through the top cover 510 and the bottom cover 520 and form a complete optical path together with the lens 140 and other elements of the optical pickup head. The top cover 510 can further form a photo-diffracting element 515 corresponding to the lens 140 and the optical path to enhance the optical characteristics of the optical pickup head.

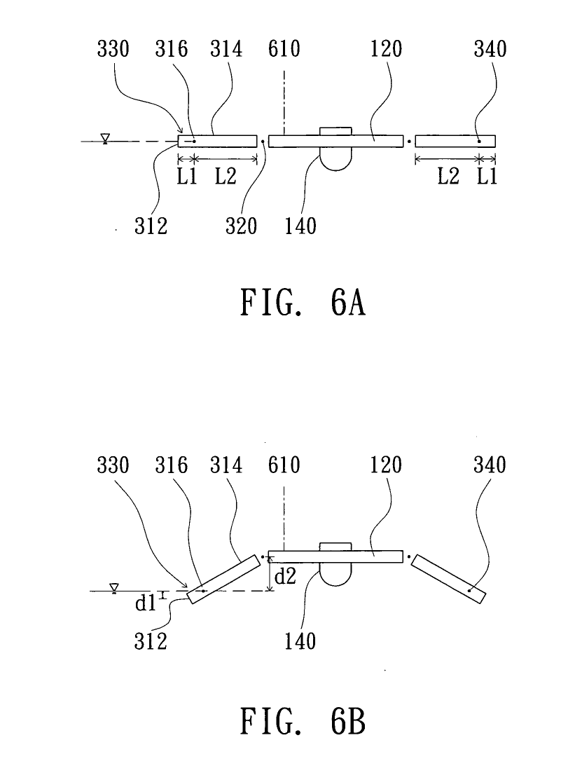

As for how the focusing device of the invention is used to increase the range of movements of the comb actuator, please refer to both FIG. 6A and FIG. 6B. FIG. 6A illustrates the upward focusing device before the lever action according to a preferred embodiment of the invention. FIG. 6B illustrates the upward focusing device after the lever action according to a preferred embodiment of the invention. Referring to FIG. 6A, the lens 140 is fixed on the carrier 120 via an elastomer. The upward focusing device 300 comprises a lever 330, a flexible linking shaft 320, a flexible supporting shaft 340, and a comb focusing actuator 350 (not illustrated in the drawing). The lever 330 comprises an effort arm 312 and a load arm 314, whose lengths are L1 and L2, respectively. The length L1 is smaller than the length L2. The lever 330 further comprises a supporting portion 316 used as a fulcrum. The lever 330 is connected to the supporting portion 316 and the frame 110 (not illustrated in the drawing) via the flexible supporting shaft 340, so that the lever 330 is rotated but not moved with respect to the frame 110 (not illustrated in the drawing). The flexible supporting shaft 340 can be used as a reference point. The lever 330 is connected to the carrier 120 via the flexible linking shaft 320 for enabling the lever 330 to rotate with respect to the carrier 120 and drive the carrier 120. Referring to FIG. 6B, the comb focusing actuator 350 (not illustrated in the drawing) applies a force on the effort arm 312 for enabling the effort end to generate a shift d1 corresponding to the flexible supporting shaft 340 along one direction of a normal line 610. Since the length L2 is larger than the length L1, according to the lever principle and the shift d1, a shift d2 corresponding to flexible supporting shaft 340 is generated at the load end along the opposite direction of the normal line 610. Since the length L2 is larger than the length L1 and the shift d2 is larger than the shift d1, the carrier 120 can generate a larger shift for focusing along the direction of the normal line 610. According to the present embodiment of the invention, when the comb focusing actuator 350 (not illustrated in the drawing) generates a shift at the effort end, an enlarged shift is generated at the load end. By adjusting the ratio between the length of the effort arm 312 and the length of the load arm 314, the range of movements of the comb focusing actuator 350 (not illustrated in the drawing) is equivalently increased, and the function of the focusing device 400 of FIG. 2 is effectively enhanced.

However, any one who is skilled in the technology of the invention will understand that the technology of the invention is not limited to the aforementioned embodiments. For example, the elements such as the carrier 120, the tracking device 130, the focusing device 400, the flexible linking shafts 220 and 320 and the flexible supporting shafts 240 and 340 can be manufactured according to a semiconductor manufacturing process. The material of the carrier 120, the tracking actuators 132 and 134 and the focusing actuators 250 and 350 includes monocrystalline silicon. The levers 230 and 330 of the focusing device need to have enough hardness in order to have enough strength in transmission. The thickness of the levers 230 and 330 is approximately equal to 80μm. The flexible supporting shafts 220 and 320 and the flexible supporting shafts 240 and 340 must have flexibility capable of being twisted, and are manufactured according to a thin film manufacturing process. The thickness of the flexible supporting shafts 220 and 320 and the flexible supporting shafts 240 and 340 is approximately equal to 2μm.

According to the optical pickup head disclosed in the above embodiments of the invention, most of the elements are manufactured according to the semiconductor manufacturing process and for mass production, hence saving the manufacturing cost. Moreover, the focusing actuator includes a lever, so that the shift of the focusing actuator is enlarged, and that the function and efficiency of the focusing actuator is enhanced. Without deteriorating the transmittance of the light source, a transparent protection cover is introduced to the top cover and the bottom cover of the optical pickup head to protect the optical pickup head from the impact of an external force and prevent the lens from contamination. The miniaturization of the overall optical pickup head is conducive to the improvement in the read/write efficiency.

The micro-optical pickup head according to the invention can have the following features. Firstly, with the design of using a micro actuator to control the tracking and focusing of an optical lens, the accuracy in positioning is increased, and with the design of introducing a lever to the focusing actuator, the range of movement of the focusing actuator is largely increased. Secondly, with the miniaturization of the pickup head, the system accessing speed is largely increased and the system accessing time is largely decreased. Thirdly, with a thorough design of the protection cover, the micro pickup head is prevented from being hit by disc during the read/write process or being damaged by dusts. Fourthly, by adopting the micro electromechanical technology in manufacturing the micro pickup head according to the semiconductor manufacturing process such as the lithography manufacturing process, the thin film deposition manufacturing process, the reactive ion etching (RIE) manufacturing process, or the deep reactive ion etching (DRIE) manufacturing process, the micro pickup head is suitable for mass production and the manufacturing cost is further decreased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical pickup head, comprising:
a frame;
a lens;
a carrier disposed in the frame for carrying the lens;
a lever having an effort arm, a load arm, and a supporting portion disposed between the effort arm and the load arm, wherein the length of the load arm is larger than the length of the effort arm, the load arm is connected to the carrier, and the supporting portion is fixed on the frame and used as a fulcrum of the lever; and
a focusing actuator for applying a force on the effort arm for enabling the carrier to move along a focusing direction.

2. The optical pickup head according to claim 1 further comprises a tracking actuator disposed on the frame for controlling the frame to move in a tracking direction.

3. The optical pickup head according to claim 2, wherein the tracking actuator is a comb tracking actuator having a pair of comb electrodes.

4. The optical pickup head according to claim 3, wherein the comb tracking actuator has a comb portion which is in an arc shape.

5. The optical pickup head according to claim 1 further comprises a flexible linking element for linking the carrier and the load arm for enabling the load arm to drive the carrier to move along the focusing direction.

6. The optical pickup head according to claim 1 further comprises a flexible supporting element for fixing the supporting portion on the frame for enabling the lever to rotate with respect to the frame.

7. The optical pickup head according to claim 1, wherein the carrier, the lever, and the focusing actuator are manufactured according to a semiconductor manufacturing process, and the material of the focusing actuator includes monocrystalline silicon.

8. The optical pickup head according to claim 1, wherein the focusing actuator is a comb focusing actuator having a pair of comb electrodes.

9. The optical pickup head according to claim 1 further comprises a protection cover having an accommodation space for accommodating the lens.

10. The optical pickup head according to claim 9, wherein the material of the protection cover includes a glass substrate or a quartz substrate.

11. The optical pickup head according to claim 9, wherein the protection cover comprises:
a top cover having a first the recess; and
a bottom cover having a second the recess;
wherein the first the recess and the second the recess together form the accommodation space.

12. The optical pickup head according to claim 11, wherein the top cover further has a photo-diffracting element disposed thereon.

13. A focusing method of an optical pickup head, comprising:
providing a carrier disposed in a frame for carrying a lens;
providing a focusing device comprising a lever and a focusing actuator, wherein the lever has an effort arm, a load arm, and a supporting portion disposed between the effort arm and the load arm, the length of the load arm is larger than the length of the effort arm, the focusing actuator is for applying a force on an effort end of the effort arm, the carrier is connected to a load end of the load arm, and the supporting portion is fixed on the frame and used as a fulcrum of the lever;
applying a force on the effort arm by using the focusing actuator for generating a first shift at the application end; and
generating a second shift larger than first shift at the load end according to the lever principle and the first shift for enabling the load arm to drive the carrier to move along a focusing direction.

14. The focusing method according to claim 13, wherein the focusing device further comprises a flexible linking element for linking the load arm and the carrier.

15. The focusing method according to claim 13, wherein the focusing device further comprises a flexible supporting element for fixing the supporting portion on the frame.

16. The focusing method according to claim 13, wherein the focusing actuator is a comb focusing actuator and has a pair of comb electrodes, the method further comprises:
applying a voltage on the comb focusing actuator for enabling the comb electrodes to have opposite polarities and generate an attraction between two comb electrodes.

17. A focusing device disposed on a frame of an optical pickup head for driving a carrier to move along a focusing direction, wherein the focusing device comprises:
a lever having an effort arm, a load arm, and a supporting portion disposed between the effort arm and the load arm, wherein the carrier is connected to the load arm, and the supporting portion is fixed on the frame and used as a fulcrum point of the lever; and
a focusing actuator for applying a force on the effort arm;
wherein the length of the load arm is larger than the length of the effort arm.

18. The focusing device according to claim 17 is manufactured according to a semiconductor manufacturing process.

19. The focusing device according to claim 17, further comprising:
a flexible linking element for linking the effort arm and the carrier; and
a flexible supporting element for fixing the supporting portion on the frame.

20. The focusing device according to claim 17, wherein the focusing actuator comprises a comb focusing actuator and has a pair of comb electrodes.
